(19) United States
(12) Patent Application Publication
(10) Pub. No.: US 2024/0046557 A1
(43) Pub. Date: Feb. 8, 2024

(54) METHOD, DEVICE, AND NON-TRANSITORY COMPUTER-READABLE STORAGE MEDIUM FOR RECONSTRUCTING A THREE-DIMENSIONAL MODEL

(71) Applicant: Zhuhai Prometheus Vision Technology Co., LTD, Zhuhai (CN)

(72) Inventors: Zhijing SHAO, Zhuhai (CN); Zhaolong WANG, Zhuhai (CN); Wei SUN, Zhuhai (CN); Yu ZHANG, Zhuhai (CN)

(21) Appl. No.: 18/093,391

(22) Filed: Jan. 5, 2023

(30) Foreign Application Priority Data
Aug. 5, 2022 (CN) 202210938748.0

(51) Int. Cl. G06T 17/00; G06T 15/06; G06T 7/50; G06T 7/73

(52) U.S. Cl. CPC G06T 17/00; G06T 15/06; G06T 7/50; G06T 7/73; G06T 2200/08; G06T 2207/10024; G06T 2207/10028; G06T 2207/20084; G06T 2207/20081; G06T 2207/30244

(57) ABSTRACT

The present application provides a method, device and computer-readable storage medium for reconstructing a three-dimensional model. The method includes obtaining shooting data of a target object, the shooting data includes an image set obtained by multiple cameras shooting the target object from different positions and camera parameters of the cameras when each image in the image set is shot, the image set includes multiple color images and a depth image corresponding to each color image; training a neural network model implicitly representing a three-dimensional model of the target object based on the shooting data; reconstructing the three-dimensional model of the target object based on a trained neural network model. The method provided by the present application implicitly models the three-dimensional model through the neural network model, and the three-dimensional model can be continuously corrected by continuous iterative training of the neural network model, improving accuracy of three-dimensional model reconstruction.

### CROSS-REFERENCE TO RELATED APPLICATION

This disclosure claims priority benefit to Chinese Patent Application No. 202210938748.0, filed on Aug. 5, 2022, and entitled “METHOD, DEVICE, AND NON-TRANSITORY COMPUTER-READABLE STORAGE MEDIUM FOR RECONSTRUCTING A THREE-DIMENSIONAL MODEL”, the entire contents of which are hereby incorporated by reference in its entirety in this application.

### FIELD OF DISCLOSURE

The present application relates to a field of three-dimensional reconstruction and artificial intelligence, and more specifically, to a method, a device, and a non-transitory computer-readable storage medium for reconstructing a three-dimensional model.

### BACKGROUND

A three-dimensional (3D) reconstruction technology refers to an establishment of a mathematical model of a three-dimensional object suitable for computer representation and processing, which is a basis for processing, operating, and analyzing its properties in a computer environment, and is also a key technology for establishing a virtual reality expressing an objective world in a computer.

After a volumetric video is shot and relevant data is collected, a three-dimensional model of an object needs to be reconstructed in the computer by a three-dimensional reconstruction technology. At present, the three-dimensional reconstruction technology is mostly realized by Poisson surface reconstruction method based on point clouds, and accuracy of the three-dimensional model reconstructed by this method is poor.

### SUMMARY

Embodiments of the present application provide a method, a device, and a non-transitory computer-readable storage medium for reconstructing a three-dimensional model, and the method can effectively improve accuracy of a three-dimensional model reconstruction.

A first aspect of the present application provides the method for reconstructing the three-dimensional model, the method includes:
acquiring shooting data of a target object, wherein the shooting data includes an image set obtained by a plurality of cameras shooting the target object from different positions and camera parameters of the cameras when each image in the image set is shot, and the image set includes a plurality of color images and a depth image corresponding to each color image;
training a neural network model that implicitly represents a three-dimensional model of the target object based on the shooting data; and
reconstructing the three-dimensional model of the target object based on a trained neural network model.

Correspondingly, a second aspect of the present application provides the device for reconstructing the three-dimensional model, the device includes:
an acquisition unit, configured to acquire shooting data of a target object, wherein the shooting data includes an image set obtained by a plurality of cameras shooting the target object from different positions and camera parameters of the cameras when each image in the image set is shot, and the image set includes a plurality of color images and a depth image corresponding to each color image;
a training unit, configured to train a neural network model that implicitly represents a three-dimensional model of the target object based on the shooting data; and
a reconstruction unit, configured to reconstruct the three-dimensional model of the target object based on a trained neural network model.

In some embodiments, the training unit includes:
a conversion subunit, configured to convert pixel points in each color image into rays based on corresponding camera parameters;
a sampling subunit, configured to sample a plurality of sampling points on each ray, and to determine first coordinate information of each sampling point and a directional distance value of each sampling point from corresponding pixel point;
a processing subunit, configured to input the first coordinate information of the sampling points into the neural network model that implicitly represents the three-dimensional model of the target object, and to obtain a predicted directional distance value and a predicted color value of each sampling point output by the neural network model; and
an adjustment subunit, configured to adjust parameters of the neural network model based on a first difference between the predicted directional distance value and the directional distance value and a second difference between the predicted color value and a color value of the pixel point to obtain the trained neural network model.

In some embodiments, the conversion subunit includes:
a first determination module, configured to determine an imaging plane of a color image according to the camera parameters;
a second determination module, configured to determine that rays passing through the pixel points in the color image and perpendicular to the imaging plane are rays corresponding to the pixel points.

In some embodiments, the first determination module includes:
a first determination submodule, configured to determine second coordinate information of the camera in a world coordinate system and a rotation angle of the camera according to the camera parameters;
a second determination submodule, configured to determine the imaging plane of the color image according to the second coordinate information and the rotation angle.

In some embodiments, the sampling subunit includes:
a first sampling module, configured to sample a first number of first sampling points at equal intervals on the ray;
a third determination module, configured to determine a plurality of key sampling points according to a depth value of the pixel point;
a second sampling module, configured to sample a second number of second sampling points based on the key sampling points, and to determine that the first number of first sampling points and the second number of second sampling points as a plurality of sampling points for sampling.

In some embodiments, the sampling subunit includes:
a fourth determination module, configured to determine a depth value corresponding to the pixel point according to the depth image corresponding to the color image;
a first calculation module, configured to calculate a directional distance value of each sampling point from the pixel point based on the depth value;
a second calculation module, configured to calculate first coordinate information of each sampling point according to the camera parameters and the depth value.

In some embodiments, the reconstruction unit includes:
an extraction subunit, configured to extract isosurfaces based on the trained neural network model to obtain surfaces of the three-dimensional model;
a reconstruction subunit, configured to reconstruct the three-dimensional model of the target object according to the surfaces of the three-dimensional model.

A third aspect of the present application further provides a non-transitory computer-readable storage medium, where the non-transitory computer-readable storage medium stores a plurality of instructions, and the instructions are adapted to be loaded by one or more processors to execute steps in the method for reconstructing the three-dimensional model provided by the first aspect of the present application.

A fourth aspect of the present application further provides a computer device, including a memory, one or more processors coupled to the memory, and a computer program stored in the memory and executable on the one or more processors, and when the computer program is executed by the one or more processors, steps in the method for reconstructing the three-dimensional model provided by the first aspect of the present application are implemented.

A fifth aspect of the present application further provides a computer program product, including computer programs/instructions, when the computer program/instructions are executed by one or more processors, steps in the method for reconstructing the three-dimensional model provided by the first aspect of the present application are implemented.

The method for reconstructing the three-dimensional model provided by the embodiments of the present application includes obtaining the shooting data of the target object, wherein the shooting data includes an image set obtained by a plurality of cameras shooting the target object from different positions and camera parameters of the cameras when each image in the image set is shot, and the image set includes a plurality of color images and a depth image corresponding to each color image; training a neural network model that implicitly represents a three-dimensional model of the target object based on the shooting data; reconstructing the three-dimensional model of the target object based on the trained neural network model.

In this way, the method for reconstructing the three-dimensional model provided by the present application implicitly models the three-dimensional model by means of the neural network model, and the three-dimensional model can be continuously corrected by continuous iterative training of the neural network model, which can greatly improve accuracy of three-dimensional model reconstruction.

### BRIEF DESCRIPTION OF DRAWINGS

To describe the technical solutions in embodiments of the present application more clearly, the following briefly describes the accompanying drawings required for describing the embodiments. Apparently, the accompanying drawings in the following description show merely some embodiments of the present application, and a person of ordinary skill in the art may still derive other accompanying drawings from these accompanying drawings without creative efforts.

FIG. 1 is a scene schematic diagram of a method for reconstructing a three-dimensional model in the present application.

FIG. 2 is a schematic flowchart of reconstruction of a three-dimensional model provided by the present application.

FIG. 3 is a schematic diagram of sampling points.

FIG. 4 is a schematic structural diagram of a device for reconstructing a three-dimensional model provided by the present application.

FIG. 5 is a schematic structural diagram of a computer device provided by the present application.

### DETAILED DESCRIPTION OF PREFERRED EMBODIMENTS

The technical solutions of the embodiments of the present application will be described clearly and completely in combination with the drawings of the embodiments of the present application. Obviously, the described embodiments are a part of the embodiments of the present application, but not all the embodiments. Based on the embodiments of the present application, the other embodiments obtained by a person of ordinary skill in the related art without inventive work fall within the scope of the present application.

Embodiments of the present application provide a method, a device, a non-transitory computer-readable storage medium, and a computer device for reconstructing a three-dimensional (3D) model. The method for reconstructing the three-dimensional model can be used in a device for reconstructing the three-dimensional model. The device for reconstructing the three-dimensional model may be integrated into a computer device, and the computer device may be a terminal or a server. The terminal may be a mobile phone, a tablet computer, a notebook computer, a smart television, a wearable smart device, a personal computer (PC), a vehicle-mounted terminal, and other devices. The server is an independent physical server, or is a server cluster or a distributed system formed by a plurality of physical servers, or is a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. The server can be a node in the blockchain.

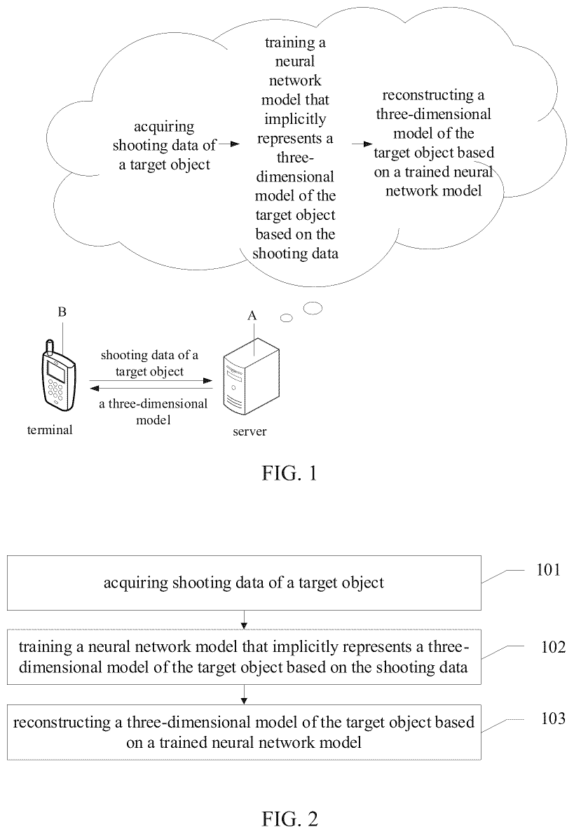

Please refer to FIG. 1, which is a scene schematic diagram of a method for reconstructing a three-dimensional model provided by the present application. As shown in the figure, a server A obtains shooting data of a target object from a terminal B. The shooting data includes an image set obtained by a plurality of cameras shooting the target object from different positions and camera parameters of the cameras when each image in the image set is shot, and the image set includes a plurality of color images and a depth image corresponding to each color image; a neural network model that implicitly represents the three-dimensional model of the target object is trained based on the shooting data; the three-dimensional model of the target object is reconstructed based on a trained neural network model.

It should be noted that a schematic diagram of reconstruction of the three-dimensional model shown in FIG. 1 is only an example, and a video search scenario described in the embodiments of the present application is intended to illustrate technical solutions of the present application more clearly, and does not constitute a limitation on the technical solutions provided in the present application. It is known to a person of ordinary skill in the art that the technical solutions provided by the present application are equally applicable to similar technical problems as reconstruction scenarios of three-dimensional model evolve and new business scenarios emerge.

Based on above implementation scenarios, detailed descriptions are given below.

In the related art, a point-clouds-based reconstruction method is generally used when performing a three-dimensional model, that is, by acquiring accurate depth images, then using the depth images to generate point clouds, and further reconstructing a three-dimensional geometric model based on the point clouds. This method makes a reconstructed geometric model affected by process accuracy, and more reconstruction processes will lead to accumulation of errors making the reconstructed geometric model less accurate. In order to solve a problem of low reconstruction accuracy of the above-mentioned method for performing a three-dimensional reconstruction based on point clouds, the present application provides a method for reconstructing a three-dimensional model in order to improve reconstruction accuracy of the three-dimensional model.

Embodiments of the present application will be described from a point of view of a device for reconstructing a three-dimensional model, and the device for reconstructing the three-dimensional model may be integrated into a computer device. The computer device may be a terminal or a server. The terminal may be a mobile phone, a tablet computer, a notebook computer, a smart television, a wearable smart device, a personal computer (PC), a vehicle-mounted terminal, and other devices. The server is an independent physical server, or a server cluster or a distributed system formed by a plurality of physical servers, or is a cloud service that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. As shown in FIG. 2, which is a schematic flowchart of reconstruction of a three-dimensional model provided by the present application, the method includes:

step 101, acquiring shooting data of a target object.

Wherein, in an embodiment of the present application, a method for reconstructing a three-dimensional model is provided, which may specifically be a three-dimensional reconstruction method for a volumetric video. Wherein the volumetric video (also known as spatial video, or volumetric three-dimensional video, or 6 degrees of freedom (DOF) video, etc.) is a technique that generates three-dimensional model sequences by capturing information (such as depth information and color information, etc.) in three-dimensional space. Compared with traditional video, the volumetric video adds a concept of space to a video, using a three-dimensional model to better restore a three-dimensional world, rather than a two-dimensional flat video with motion shots to simulate a sense of space in the three-dimensional world. Since the volumetric video is essentially a three-dimensional model sequence, it allows users to adjust to any viewing angle to watch according to their preferences, which has a higher degree of restoration and immersion than the two-dimensional flat video.

Shooting of volumetric video can use multiple industrial cameras and depth cameras to shoot multiple angles of a target object (subject) in a studio at same time to obtain shooting data. That is, at each moment, a plurality of color images of the target object from multiple angles and a depth image corresponding to each color image can be captured. That is, when shooting, the industrial cameras and the depth cameras can be configured in a camera group, with one industrial camera cooperating with one depth camera to shoot the target object.

In addition, in an embodiment of the present application, the camera parameters of the cameras at each shooting moment may be further obtained. The camera parameters include internal parameters of the cameras and external parameters of the cameras; the internal parameters of the cameras can be parameters related to characteristics of the cameras, which can specifically include data such as focal length and pixels of the cameras; the external parameters of the cameras can be parameters of the cameras in a world coordinate system, which can specifically include data such as position (coordinates) of the cameras and rotation direction of the cameras. Camera parameters can be determined by calibration, wherein, in a process of image measurement and machine vision applications, in order to determine a relationship between a three-dimensional geometric position of a point on a surface of a spatial object and its corresponding point in an image, a geometric model of camera imaging must be established, and these geometric model parameters are camera parameters. In most conditions, these parameters must be obtained through experiments and calculations, and a process of solving for the parameters (internal parameters, external parameters, and distortion parameters) is called camera calibration (or video camera calibration). Whether in image measurement or machine vision applications, the calibration of camera parameters is a very critical part of the process, and accuracy of calibration results and stability of algorithms directly affect accuracy of results produced by a camera work. Therefore, a good camera calibration is a prerequisite for good follow-up work, and improvement of calibration accuracy is focus of scientific research.

Step 102, training a neural network model that implicitly represents a three-dimensional model of the target object based on the shooting data.

Wherein, after obtaining the shooting data of the target object, that is, the shooting data obtained by shooting the volumetric video of the target object, including the color images and the depth images of the target object from multiple viewpoints at different times, it is necessary to perform a three-dimensional reconstruction of the target object based on the shooting data obtained from the shooting. In related art, pixels are often converted into voxels based on depth information of pixel points in a captured image to obtain point clouds, and then the three-dimensional reconstruction is performed based on the point clouds. However, as mentioned earlier, the reconstruction accuracy of this method is low. In the embodiments of the present application, a method for performing three-dimensional reconstruction based on a neural network model is provided. Specifically, a neural network model that implicitly represents the three-dimensional model of the target object can be trained, and then the three-dimensional model of the target object is reconstructed based on the neural network model.

The neural network model can be a multi-layer perceptron (MLP) that does not include a normalization layer. The neural network model can be trained by using the camera parameters in aforementioned shooting data and corresponding captured color images and depth images. Specifically, the internal parameters and the external parameters included in the camera parameters can be used as an input of the neural network model, and output data of the neural network model can be volumetrically rendered to obtain the corresponding depth images and color images, and then parameters of the neural network model can be adjusted based on differences between the depth images and the color images rendered by the neural network model and actual depth images and actual color images corresponding to the camera parameters, i.e., based on the actual depth images and the actual color images corresponding to the camera parameters are used as a supervision of a model training, the neural network model is continuously iteratively trained to obtain a trained neural network model.

In some embodiments, a step of training the neural network model that implicitly represents the three-dimensional model of the target object based on the shooting data includes:
1. converting pixel points in each color image into rays based on corresponding camera parameters;
2. sampling a plurality of sampling points on each ray and determining first coordinate information of each sampling point and a directional distance value of each sampling point from corresponding pixel point;
3. inputting the first coordinate information of the sampling points into the neural network model that implicitly represents the three-dimensional model of the target object, and obtaining a predicted directional distance value and a predicted color value of each sampling point output by the neural network model; and
4. adjusting the parameters of the neural network model based on a first difference between the predicted directional distance value and the directional distance value and a second difference between the predicted color value and a color value of the pixel point to obtain the trained neural network model.

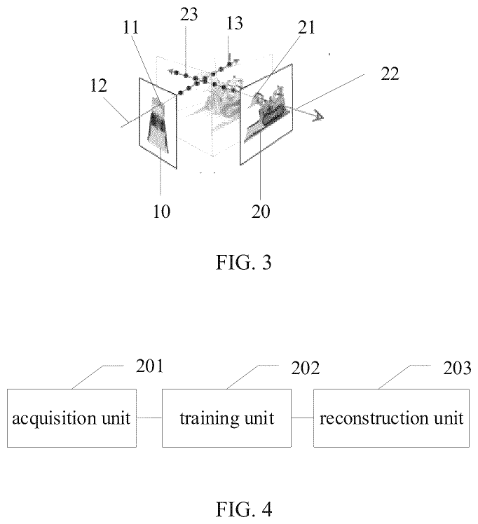

Specifically, in an embodiment of the present application, a specific step of training a neural network model based on camera parameters and corresponding color images and depth images may be to first convert a pixel point in the color image obtained by shooting into a ray based on the camera parameters. Then, a plurality of sampling points are sampled on each ray, and the first coordinate information of each sampling point and the directional distance value of each sampling point from the pixel point are determined. As shown in FIG. 3, a schematic diagram of sampling points is shown. As shown in the figure, a first color image 10 and a second color image 20 are color images obtained by shooting the target object from different angles, where a first pixel point 11 is any pixel point in the first color image 10, and a second pixel point 21 is any pixel point in the second color image 20. A first ray 12 is a ray generated based on a first camera parameters corresponding to the first color image 10, and a second ray 22 is a ray generated based on a second camera parameters corresponding to the second color image 20. First sampling points 13 are a plurality of sampling points sampled on the first ray 12, and second sampling points 23 are a plurality of sampling points sampled on the second ray 22.

Wherein, after a plurality of sampling points are obtained by sampling, the first coordinate information of each sampling point and the directional distance value of each sampling point from corresponding pixel point may be further determined. Here, the directional distance value may be a difference between a depth value of the pixel point and a distance of the sampling point from an imaging plane of a camera, and the difference value is a signed value. The directional distance value here can also be called a signed distance function (SDF) value, where the SDF value of the sampling point is negative when the sampling point is inside the target object, and the SDF value of the sampling point is positive when the sampling point is outside the target object, and the SDF of the sampling point is zero when the sampling point is on a surface of the target object. That is, the directional distance value between the sampling point and the corresponding pixel point here also indicates a positional relationship between the sampling point and the three-dimensional model. Then, the first coordinate information of each sampling point is input into the neural network model that implicitly represents the three-dimensional model of the target object, and the predicted directional distance value and the predicted color value output by the neural network model are obtained. Then, the neural network model is iteratively trained with an actual color value of the pixel point in the color image corresponding to the camera parameters and an actual depth value of the pixel in the depth image corresponding to the camera parameters as supervision until model parameters of the neural network model converge and the trained neural network model is obtained.

In some embodiments, a step of converting pixel points in each color image into rays based on corresponding camera parameters includes:
1.1 determining an imaging plane of the color image according to the camera parameters;
1.2. determining that rays passing through pixel points in the color image and perpendicular to the imaging plane are rays corresponding to the pixel points.

Wherein, in an embodiment of the present application, a specific method of ray transformation of the pixel point in the corresponding color image based on the camera parameters may be to first determine coordinate information of the image captured by a camera in the world coordinate system according to the internal parameters and the external parameters of the camera, that is, to determine the imaging plane. Then, a ray passing through a pixel point in the color image and perpendicular to the imaging plane can be determined as a ray corresponding to the pixel point. Further, each pixel point in the color image can be traversed to generate a ray corresponding to each pixel point.

In some embodiments, a step of determining the imaging plane of the color image based on camera parameters includes:
1.1.1. determining second coordinate information of the camera in the world coordinate system and a rotation angle of the camera according to the camera parameters;
1.1.2. determining the imaging plane of the color image according to the second coordinate information and the rotation angle.

Wherein, in an embodiment of the present application, the imaging plane of the color image is determined according to the camera parameters. Specifically, the second coordinate information of the camera in the world coordinate system and the rotation angle of the camera can be extracted from the camera parameters, and then coordinate data of the imaging plane of the camera in the world coordinate system can be determined based on the external camera parameters such as the second coordinate information of the camera in the world coordinate system and the rotation angle.

In some embodiments, a step of sampling a plurality of sampling points on each ray includes:
2.1. sampling a first number of first sampling points at equal intervals on the ray;
2.2. determining a plurality of key sampling points according to a depth value of the pixel point;
2.3. sampling a second number of second sampling points based on the key sampling points, and determining the first number of first sampling points and the second number of second sampling points as a plurality of sampling points for sampling.

Wherein, in an embodiment of the present application, the sampling points are sampled in the ray generated based on the pixel point, which can be specifically n sampling points uniformly on the ray first, where n is a positive integer greater than 2, and then m sampling points are sampled at a significant location based on the depth value of the aforementioned pixel point, where m is a positive integer greater than 1, and then n+m sampling points obtained from the sampling are used as final sampling points. Wherein, the significant location can be positions at closer distance from the pixel point, that is, positions closer to a surface of the model. Among n sampling points, the sampling point closer to the surface of the model may be specifically referred to as the key sampling point. The step of sampling m sampling points at the significant location means sampling m sampling points at the key sampling points. By re-sampling m sampling points at the key sampling points, training effect of the model can be made more accurate on the surface of the three-dimensional model, thereby further improving reconstruction accuracy of the three-dimensional model.

In some embodiments, a step of determining the first coordinate information of each sampling point and the directional distance value of each sampling point from corresponding pixel point includes:
determining a depth value corresponding to the pixel point according to the depth image corresponding to the color image;
calculating the directional distance value of each sampling point from the pixel point based on the depth value;
calculating the first coordinate information of each sampling point according to the camera parameters and the depth value.

Wherein, in an embodiment of the present application, after a plurality of pixel points on the ray corresponding to each pixel point, a distance between a camera shooting position and the pixel point can be determined according to the external parameters of the camera and the depth information of the pixel point (read from the depth image), and then directional distance data of each sampling point is calculated based on this distance one by one as well as the first coordinate information of each sampling point is calculated.

Step 103, reconstructing a three-dimensional model of the target object based on the trained neural network model.

Wherein, after training the neural network model that implicitly represents the three-dimensional model of the target object, the trained neural network model is obtained, that is, the neural network model can be understood as the aforementioned signed distance function, that is, for a given coordinate information of any point, its corresponding SDF value can be determined by the neural network model, and the SDF value can represent a positional relationship (internal, external, or surface) between the point and the three-dimensional model, then the neural network model can also implicitly represent the three-dimensional model. By training the neural network model for several iterations, a more accurate three-dimensional model can be obtained. That is, after the neural network model is trained, a more accurate three-dimensional model of the target object can be reconstructed, so that a volumetric video with clearer texture and better realism can be obtained.

In some embodiments, a step of reconstructing the three-dimensional model of the target object based on the trained neural network model includes:
1. extracting isosurfaces based on the trained neural network model to obtain surfaces of the three-dimensional model;
2. reconstructing the three-dimensional model of the target object according to the surfaces of the three-dimensional model.

In an embodiment of the present application, after training a neural network model that implicitly represents a three-dimensional model, only a virtual model is obtained, and further isosurface extraction of the neural network model is required, i.e., an isosurface extraction algorithm (Marching Cubes, MC) is used to draw the surfaces of the three-dimensional model to obtain the surfaces of the three-dimensional model, and then the three-dimensional model of the target object is determined based on the surfaces of the three-dimensional model.

Using the method for reconstructing the three-dimensional model provided by the present application, the three-dimensional model is implicitly modeled through the neural network model, and adding depth information can improve accuracy of training speed of the neural network model, and the three-dimensional model learned by the network is re-rendered back to the picture for indirect correction of the model, and the three-dimensional model is gradually corrected through continuous iteration, so that the three-dimensional model is more accurate.

According to the above description, the method for reconstructing the three-dimensional model provided by the embodiments of the present application is performed by obtaining the shooting data of the target object, wherein the shooting data includes an image set obtained by a plurality of cameras shooting the target object from different positions and camera parameters of the cameras when each image in the image set is shot, and the image set includes a plurality of color images and a depth image corresponding to each color image; training a neural network model that implicitly represents a three-dimensional model of the target object based on the shooting data; and reconstructing a three-dimensional model of the target object based on a trained neural network model. The method for reconstructing the three-dimensional model provided by the present application implicitly models the three-dimensional model by means of the neural network model, and the three-dimensional model can be continuously corrected by continuous iterative training of the neural network model, which can greatly improve accuracy of three-dimensional model reconstruction.

In order to better implement the above method for reconstructing the three-dimensional model, an embodiment of the present application further provides a device for reconstructing the three-dimensional model, and the device for reconstructing the three-dimensional model may be integrated in a terminal or a server.

For example, as shown in FIG. 4, a schematic diagram of the structure of the device for restricting the three-dimensional model provided by the embodiments of the present application, the device for constructing the three-dimensional model may include an acquisition unit 201, a training unit 202, and a reconstruction unit 203, as follows:
the acquisition unit 201, configured to acquire shooting data of a target object, wherein the shooting data includes an image set obtained by a plurality of cameras shooting the target object from different positions and camera parameters of the cameras when each image in the image set is shot, and the image set includes a plurality of color images and a depth image corresponding to each color image;
the training unit 202, configured to train a neural network model that implicitly represents a three-dimensional model of the target object based on the shooting data; and
the reconstruction unit 203, configured to reconstruct the three-dimensional model of the target object based on a trained neural network model.

In some embodiments, the training unit includes:
a conversion subunit, configured to convert pixel points in each color image into rays based on corresponding camera parameters;
a sampling subunit, configured to sample a plurality of sampling points on each ray, and to determine first coordinate information of each sampling point and a directional distance value of each sampling point from corresponding pixel point;
a processing subunit, configured to input the first coordinate information of the sampling points into the neural network model that implicitly represents the three-dimensional model of the target object, and to obtain a predicted directional distance value and a predicted color value of each sampling point output by the neural network model; and
an adjustment subunit, configured to adjust parameters of the neural network model based on a first difference between the predicted directional distance value and the directional distance value and a second difference between the predicted color value and a color value of the pixel point to obtain the trained neural network model.

In some embodiments, the conversion subunit includes:
a first determination module, configured to determine an imaging plane of a color image according to the camera parameters;
a second determination module, configured to determine that rays passing through the pixel points in the color image and perpendicular to the imaging plane are rays corresponding to the pixel points.

In some embodiments, the first determination module includes:
a first determination submodule, configured to determine second coordinate information of the camera in the world coordinate system and a rotation angle of the camera according to the camera parameters;
a second determination submodule, configured to determine an imaging plane of the color image according to the second coordinate information and the rotation angle.

In some embodiments, the sampling subunit includes:
a first sampling module, configured to sample a first number of first sampling points at equal intervals on the ray;
a third determination module, configured to determine a plurality of key sampling points according to a depth value of the pixel point;
a second sampling module, configured to sample a second number of second sampling points based on the key sampling points, and to determine that the first number of first sampling points and the second number of second sampling points as a plurality of sampling points for sampling.

In some embodiments, the sampling subunit includes:
a fourth determination module, configured to determine a depth value corresponding to the pixel point according to the depth image corresponding to the color image;
a first calculation module, configured to calculate a directional distance value of each sampling point from the pixel point based on the depth value;
a second calculation module, configured to calculate the first coordinate information of each sampling point according to the camera parameters and the depth value.

In some embodiments, the reconstruction unit includes:
an extraction subunit, configured to extract isosurfaces based on the trained neural network model to obtain surfaces of the three-dimensional model;
a reconstruction subunit, configured to reconstruct the three-dimensional model of the target object according to the surfaces of the three-dimensional model.

During specific implementation, the above units may be implemented as separate entities, or may be combined in any way and implemented as one or several entities. Reference may be made to the foregoing method embodiment for the specification implementation of the above units, and details are not repeated any further herein.

As can be known from above, the device for reconstructing a three-dimensional model provided by the embodiments of the present application acquires the shooting data of the target object through the acquisition unit 201, wherein the shooting data includes an image set obtained by a plurality of cameras shooting the target object from different positions, and camera parameters of the cameras when each image in the image set is shot, and the image set includes a plurality of color images and a depth image corresponding to each color image, and trains a neural network model that implicitly represents the three-dimensional model of the target object based on the shooting data through the training unit 202, and reconstructs the three-dimensional model of the target object based on a trained neural network model through the reconstruction unit 203. The device for reconstructing the three-dimensional model provided by the present application implicitly models the three-dimensional model by means of the neural network model, and the three-dimensional model can be continuously corrected by continuous iterative training of the neural network model, which can greatly improve the accuracy of the three-dimensional model reconstruction.

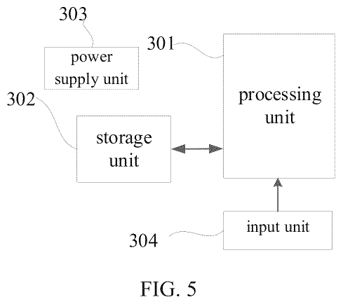

An embodiment of the present application further provides a computer device, and the computer device may be a terminal or a server, as shown in FIG. 5, which is a schematic structural diagram of the computer device provided by the present application. Specifically:
the computer device may include components such as a processing unit 301 including one or more processing cores, a storage unit 302 including one or more storage medium, a power supply unit 303, and an input unit 304. A person of ordinary skill in the art may understand that a structure of the computer device shown in FIG. 5 does not constitute a limitation to the computer device. The computer device may include components that are more or fewer than those shown in the figure, or some components may be combined, or a different component deployment may be used.

The processing unit 301 is a control center of the computer device, and is connected to various parts of the entire computer device by using various interfaces and/or lines. By running or executing software programs and/or modules stored in the storage unit 302, and invoking data stored in the storage unit 302, the processor performs various functions and data processing of the computer device. Optionally, the processing unit 301 may include one or more processing cores. Preferably, the processing unit 301 may integrate an application processor and a modem processor. The application processor mainly processes an operating system, a user interface, an application program, and the like. The modem processor mainly processes wireless communication. It may be understood that the foregoing modem processor may alternatively not be integrated into the processing unit 301.

The storage unit 302 may be configured to store a software program and module. The processing unit 301 runs the software program and module stored in the storage unit 302, to implement various functional applications and data processing. The storage unit 302 may mainly include a program storage area and a data storage area. The program storage area may store an operating system, an application program required by at least one function (for example, a sound playback function, an image display function, and a web page access function, etc.), and the like. The data storage area may store data created according to use of the computer device, and the like. In addition, the storage unit 302 may include a high-speed random access memory, and may also include a non-volatile memory, such as at least one magnetic disk storage device, a flash memory, or another volatile solid-state storage device. Correspondingly, the storage unit 302 may further include a memory controller, so that the processing unit 301 may access the storage unit 302.

The computer device further includes a power supply unit 303 for supplying power to the components. Preferably, the power supply unit 303 may be logically connected to the processing unit 301 by using a power management system, thereby implementing functions such as charging, discharging, and power consumption management by using the power management system. The power supply unit 303 may further include one or more of a direct current or alternating current power supply, a re-charging system, a power failure detection circuit, a power supply converter or inverter, a power supply state indicator, and any other components.

The computer device may further include the input unit 304. The input unit 304 may be configured to receive input digit or character information and generate keyboard, mouse, joystick, optical, or trackball signal input related to user settings and function control.

Although not shown in the figure, the computer device may further include a display unit, and the like. Details are not described herein again. In an example embodiment, the processing unit 301 in the computer device may load executable files corresponding to processes of one or more application programs to the storage unit 302 according to the following instructions, and the processing unit 301 runs the application programs stored in the storage unit 302, to implement various functions:
acquiring shooting data of a target object, wherein the shooting data includes an image set obtained by a plurality of cameras shooting the target object from different positions and camera parameters of the cameras when each image in the image set is shot, and the image set includes a plurality of color images and a depth image corresponding to each color image; training a neural network model that implicitly represents a three-dimensional model of the target object based on the shooting data; and reconstructing the three-dimensional model of the target object based on a trained neural network model.

It should be noted that the computer device provided by the embodiments of the present application and the method in the above embodiments belong to the same concept, and the specific implementation of the above operations can refer to the previous embodiments, which will not be repeated here.

A person of ordinary skill in the art would understand that all or some of steps in various methods in the foregoing embodiments can be completed through instructions or completed through hardware related to instruction control. The instructions may be stored in a non-transitory computer-readable storage medium and loaded and executed by the processor.

For this, an embodiment of the present application provides a non-transitory computer-readable storage medium, storing a plurality of instructions, where the instructions can be loaded by one or more processors, to perform steps in any method provided in the embodiments of the present application. For example, the instructions may be executed by the processor to complete the following operations:
acquiring shooting data of a target object, wherein the shooting data includes an image set obtained by a plurality of cameras shooting the target object from different positions and camera parameters of the cameras when each image in the image set is shot, and the image set includes a plurality of color images and a depth image corresponding to each color image; training a neural network model that implicitly represents a three-dimensional model of the target object based on the shooting data; and reconstructing the three-dimensional model of the target object based on a trained neural network model.

For specific implementations of the foregoing operations, refer to the foregoing embodiments. Details are not described herein again.

A computer-readable storage medium may include: a read-only memory (ROM), a random access memory (RAM), a magnetic disk, or an optical disc.

Because the instructions stored in the non-transitory computer-readable storage medium can perform steps in any method provided in the embodiments of the present application, the instructions can implement beneficial effects achieved by any method provided in the embodiments of the present application. For details, refer to the foregoing embodiments. Details are not described herein again.

According to one aspect of the present application, the embodiments of the present application provide a computer program product or a computer program. The computer program product or the computer program includes computer instructions, the computer instructions being stored in a storage medium. A processor of a computer device reads the computer instructions from the storage medium, and executes the computer instructions, to cause the computer device to perform the method provided in the various optional implementation manners of the above method for reconstructing the three-dimensional model.

The method, the device, and the non-transitory computer-readable storage medium for reconstructing a three-dimensional model provided in the embodiments of the present application are described above in detail. Although the principles and implementations of the present application are described by using specific embodiments in the specification, the foregoing descriptions of the embodiments are only intended to help understand the method and core idea of the method of the present application. Meanwhile, a person of ordinary skill in the art may make modifications to the specific implementations and application range according to the idea of the present application. In conclusion, the content of the specification should not be construed as a limitation to the present application.

What is claimed is:

1. A method for reconstructing a three-dimensional model, wherein the method comprises:
acquiring shooting data of a target object, wherein the shooting data comprises an image set obtained by a plurality of cameras shooting the target object from different positions and camera parameters of the cameras when each image in the image set is shot, and the image set comprises a plurality of color images and a depth image corresponding to each color image;
training a neural network model that implicitly represents a three-dimensional model of the target object based on the shooting data; and
reconstructing the three-dimensional model of the target object based on a trained neural network model.

2. The method as claimed in claim 1, wherein a step of training the neural network model that implicitly represents the three-dimensional model of the target object based on the shooting data comprises:
converting pixel points in each color image into rays based on corresponding camera parameters;
sampling a plurality of sampling points on each ray and determining first coordinate information of each sampling point and a directional distance value of each sampling point from corresponding pixel point;
inputting the first coordinate information of the sampling points into the neural network model that implicitly represents the three-dimensional model of the target object, and obtaining a predicted directional distance value and a predicted color value of each sampling point output; and
adjusting parameters of the neural network model based on a first difference between the predicted directional distance value and the directional distance value and a second difference between the predicted color value and a color value of the pixel point to obtain the trained neural network model.

3. The method as claimed in claim 2, wherein a step of converting pixel points in each color image into rays based on corresponding camera parameters comprises:
determining an imaging plane of the color image according to the camera parameters;
determining that rays passing through pixel points in the color image and perpendicular to the imaging plane are rays corresponding to the pixel points.

4. The method as claimed in claim 3, wherein a step of determining the imaging plane of the color image based on camera parameters comprises:
determining second coordinate information of the camera in a world coordinate system and a rotation angle of the camera according to the camera parameters;
determining the imaging plane of the color image according to the second coordinate information and the rotation angle.

5. The method as claimed in claim 2, wherein a step of sampling a plurality of sampling points on each ray comprises:
sampling a first number of first sampling points at equal intervals on each ray;
determining a plurality of key sampling points according to a depth value of the pixel point;
sampling a second number of second sampling points based on the key sampling points, and determining the first number of first sampling points and the second number of second sampling points as a plurality of sampling points for sampling.

6. The method as claimed in claim 2, wherein a step of determining the first coordinate information of each sampling point and the directional distance value of each sampling point from the pixel point comprises:
determining a depth value corresponding to the pixel point according to the depth image corresponding to the color image;
calculating the directional distance value of each sampling point from the pixel point based on the depth value;
calculating the first coordinate information of each sampling point according to the camera parameters and the depth value.

7. The method as claimed in claim 1, wherein a step of reconstructing the three-dimensional model of the target object based on the trained neural network model comprises:
extracting isosurfaces based on the trained neural network model to obtain surfaces of the three-dimensional model;
reconstructing the three-dimensional model of the target object according to the surfaces of the three-dimensional model.

8. A non-transitory computer-readable storage medium storing a plurality of instructions executable by one or more processors to perform:
acquiring shooting data of a target object, wherein the shooting data comprises an image set obtained by a plurality of cameras shooting the target object from different positions and camera parameters of the cameras when each image in the image set is shot, and the image set comprises a plurality of color images and a depth image corresponding to each color image;
training a neural network model that implicitly represents a three-dimensional model of the target object based on the shooting data; and
reconstructing the three-dimensional model of the target object based on a trained neural network model.

9. The non-transitory computer-readable storage medium as claimed in claim 8, wherein the instructions are executable by the one or more processors to further perform:
converting pixel points in each color image into rays based on corresponding camera parameters;
sampling a plurality of sampling points on each ray and determining first coordinate information of each sampling point and a directional distance value of each sampling point from corresponding pixel point;
inputting the first coordinate information of the sampling points into the neural network model that implicitly represents the three-dimensional model of the target object, and obtaining a predicted directional distance value and a predicted color value of each sampling point output; and
adjusting parameters of the neural network model based on a first difference between the predicted directional distance value and the directional distance value and a second difference between the predicted color value and a color value of the pixel point to obtain the trained neural network model.

10. The non-transitory computer-readable storage medium as claimed in claim 9, wherein the instructions are executable by the one or more processors to further perform:
determining an imaging plane of the color image according to the camera parameters;
determining that rays passing through pixel points in the color image and perpendicular to the imaging plane are rays corresponding to the pixel points.

11. The non-transitory computer-readable storage medium as claimed in claim 10, wherein the instructions are executable by the one or more processors to further perform:
determining second coordinate information of the camera in a world coordinate system and a rotation angle of the camera according to the camera parameters;
determining the imaging plane of the color image according to the second coordinate information and the rotation angle.

12. The non-transitory computer-readable storage medium as claimed in claim 9, wherein the instructions are executable by the one or more processors to further perform:
sampling a first number of first sampling points at equal intervals on each ray;
determining a plurality of key sampling points according to a depth value of the pixel point;
sampling a second number of second sampling points based on the key sampling points and determining the first number of first sampling points and the second number of second sampling points as a plurality of sampling points for sampling.

13. The non-transitory computer-readable storage medium as claimed in claim 9, wherein the instructions are executable by the one or more processors to further perform:
determining a depth value corresponding to the pixel point according to the depth image corresponding to the color image;
calculating the directional distance value of each sampling point from the pixel point based on the depth value;
calculating the first coordinate information of each sampling point according to the camera parameters and the depth value.

14. The non-transitory computer-readable storage medium as claimed in claim 8, wherein the instructions are executable by the one or more processors to further perform:
extracting isosurfaces based on the trained neural network model to obtain surfaces of the three-dimensional model;
reconstructing the three-dimensional model of the target object according to the surfaces of the three-dimensional model.

15. A computer device, comprising: a memory, one or more processors coupled to the memory, and a computer program stored in the memory and executable on the one or more processors, the one or more processors being configured to:
acquire shooting data of a target object, wherein the shooting data comprises an image set obtained by a plurality of cameras shooting the target object from different positions and camera parameters of the cameras when each image in the image set is shot, and the image set comprises a plurality of color images and a depth image corresponding to each color image;
train a neural network model that implicitly represents a three-dimensional model of the target object based on the shooting data; and
reconstruct the three-dimensional model of the target object based on a trained neural network model.

16. The computer device as claimed in claim 15, wherein the one or more processors are further configured to:
convert pixel points in each color image into rays based on corresponding camera parameters;
sample a plurality of sampling points on each ray and determine first coordinate information of each sampling point and a directional distance value of each sampling point from corresponding pixel point;
input the first coordinate information of the sampling points into the neural network model that implicitly represents the three-dimensional model of the target object, and obtain a predicted directional distance value and a predicted color value of each sampling point output; and
adjust parameters of the neural network model based on a first difference between the predicted directional distance value and the directional distance value and a second difference between the predicted color value and a color value of the pixel point to obtain the trained neural network model.

17. The computer device as claimed in claim 16, wherein the one or more processors are further configured to:
determine an imaging plane of the color image according to the camera parameters;
determine that rays passing through pixel points in the color image and perpendicular to the imaging plane are rays corresponding to the pixel points.

18. The computer device as claimed in claim 17, wherein the one or more processors are further configured to:
determine second coordinate information of the camera in a world coordinate system and a rotation angle of the camera according to the camera parameters;
determine the imaging plane of the color image according to the second coordinate information and the rotation angle.

19. The computer device as claimed in claim 16, wherein the one or more processors are further configured to:
sample a first number of first sampling points at equal intervals on each ray;
determine a plurality of key sampling points according to a depth value of the pixel point;
sample a second number of second sampling points based on the key sampling points and determine the first number of first sampling points and the second number of second sampling points as a plurality of sampling points for sampling.

20. The computer device as claimed in claim 16, wherein the one or more processors are further configured to:
determine a depth value corresponding to the pixel point according to the depth image corresponding to the color image;
calculate the directional distance value of each sampling point from the pixel point based on the depth value;
calculate the first coordinate information of each sampling point according to the camera parameters and the depth value.
